(19) United States
(12) Patent Application Publication
(10) Pub. No.: US 2009/0261645 A1
(43) Pub. Date: Oct. 22, 2009

(54) Trailer with tiltable platform section

(76) Inventors: Rene Bellerose, Sherbrooke (CA); Alexandre Bellerose, Sherbrooke (CA)

Correspondence Address: BCF LLP, 1100 RENE'-LE'VESQUE BLVD. WEST, 25TH FLOOR, MONTREAL, QC, H3B-5C9, CA

(21) Appl. No.: 12/314,333

(22) Filed: Dec. 8, 2008

Related U.S. Application Data
(60) Provisional application No. 60/996,854, filed on Dec. 7, 2007.

(51) Int. Cl. B60P 1/28

(52) U.S. Cl. 298/5

(57) ABSTRACT

There is provided a trailer with a tiltable platform section comprising a mainframe; a subframe pivotally attached to the mainframe; a rear platform section fixedly attached to the mainframe; a front platform section fixedly attached to the subframe; and a retaining mechanism for attaching in a locked position the mainframe to the subframe. In an unlocked position of the mainframe, the rear platform section and the mainframe can jointly pivot relative to the front platform section.

### FIELD OF THE INVENTION

The present invention generally relates to a trailer. More specifically, the present invention is concerned with a trailer having a tiltable platform.

### BACKGROUND OF THE INVENTION

The loading onto trailers of vehicles, such as motorcycles, motorbikes, boating equipment and the like can be difficult, particularly where the vehicle is weighty and cumbersome and the trailer bed is elevated. These difficulties often persist even with the use of load ramps, for instance where the vehicle is pushed up a steep incline. In additional to the work effort involved, maintaining secure control of the vehicle during movement can be difficult and dangerous.

To overcome these difficulties, trailers having a tiltable platform have been proposed, such as in U.S. Pat. No. 6,447,237-B1 issued on Sep. 10, 2002 to Haynes. However, some still have recourse to load ramps, while others cannot be easily handled, as the whole platform is tilted.

### SUMMARY OF THE INVENTION

It is therefore an aim of the present invention to provide a trailer having a novel platform.

According to the present invention, there is provided a trailer having a tiltable platform section.

More specifically, in accordance with the present invention, there is provided a trailer comprising: a mainframe; a subframe pivotally attached to the mainframe; a first platform section attached to the mainframe; a second platform section attached to the subframe; and a retaining means for attaching the mainframe to the subframe; the retaining means being adapted, when released to allow the first platform section to pivot relative to the second platform section.

The foregoing and other objects, advantages and features of the present invention will become more apparent upon reading of the following non-restrictive description of an illustrative embodiment thereof, given by way of example only, with reference to the accompanying drawings.

### BRIEF DESCRIPTION OF THE DRAWINGS

In the appended drawings:

FIG. 1 is top perspective view of a trailer with a tiltable platform section, which is shown in a locked position thereof, in accordance with a non-restrictive illustrative embodiment of the present invention;

FIG. 2 is a bottom perspective view of the trailer of FIG. 1, in a locked position;

FIG. 3 is a side elevation view of the trailer of FIG. 1, in a locked position;

FIG. 4 is a top plan view of the trailer of FIG. 1, in a locked position;

FIG. 5 is a top perspective view of the trailer of FIG. 1, except herein shown in an unlocked position thereof;

FIG. 6 is a bottom perspective view of the trailer of FIG. 5, in the unlocked position;

FIG. 7 is a side elevation view of the trailer of FIG. 5, in the unlocked position; and

FIG. 8 is a top plan view of the trailer of FIG. 5, in the locked position.

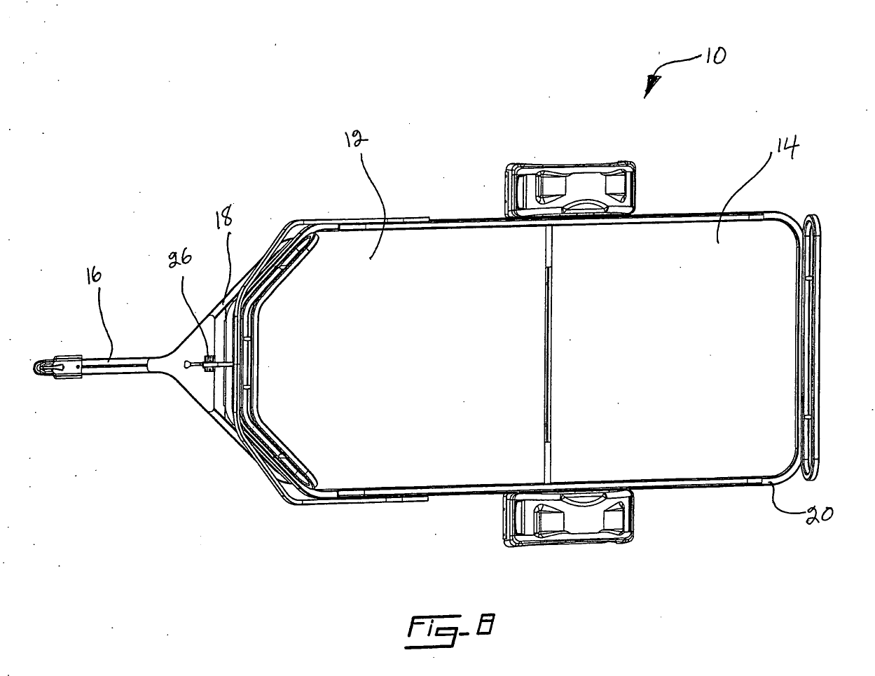

### DETAILED DESCRIPTION OF THE INVENTION

A trailer with a tiltable platform section according to a non-restrictive illustrative embodiment of the present invention will now be described.

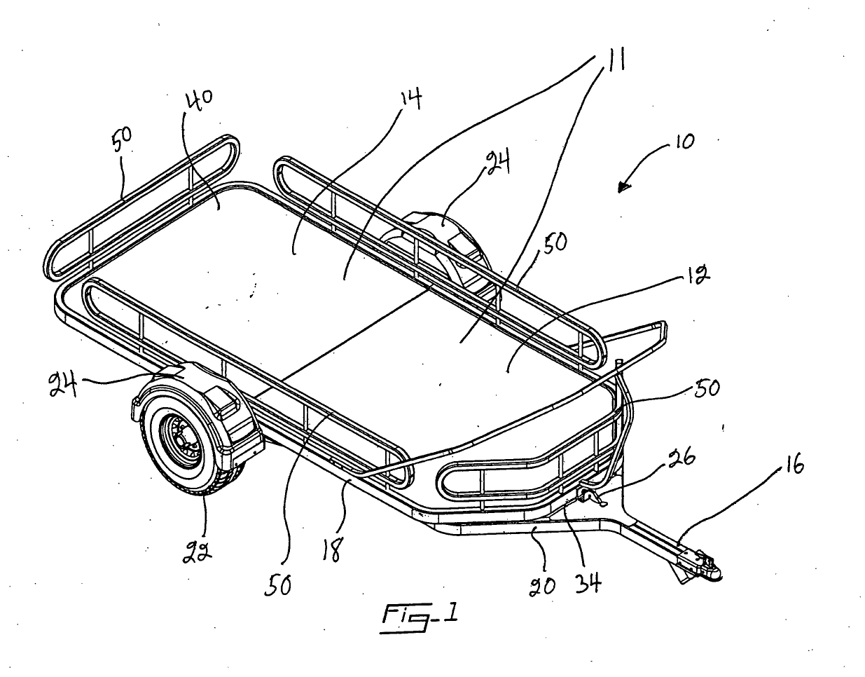

Referring now to FIG. 1, a trailer 10 comprises a platform 11 including a front platform section 12, a rear platform section 14. The trailer 10 also includes a drawbar 16, a mainframe 18, a subframe 20, two wheels 22 each associated with a respective fender 24, and a pin assembly 26. The rear platform 14 is fixedly attached to mainframe 18, whereas front platform 12 is fixedly attached to subframe 20. Drawbar 16 is a forward extension of subframe 18. Removable guards 50 are mounted on the external periphery of the front and rear platform sections 12 and 14.

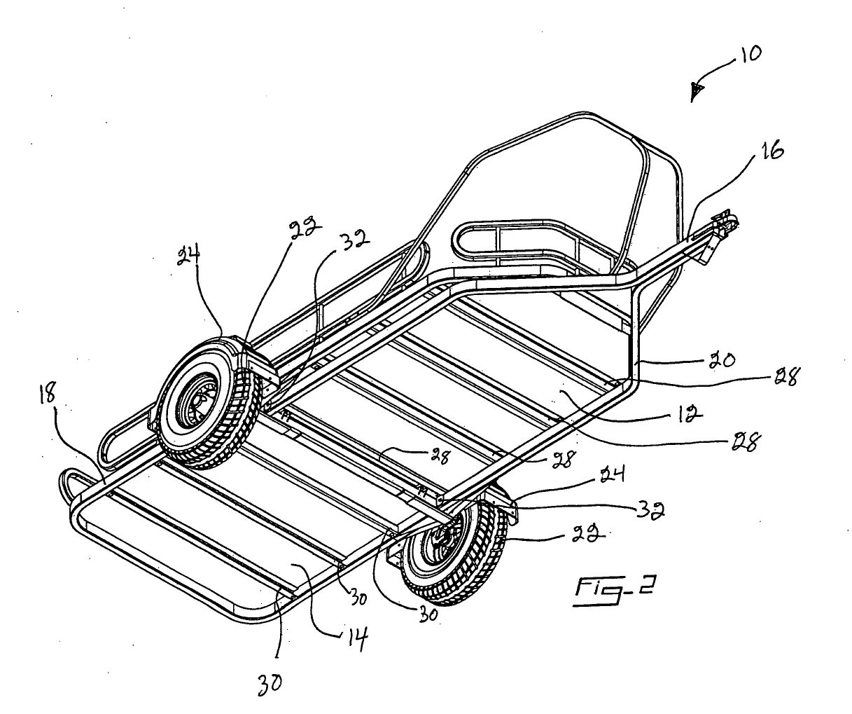

Now turning to FIG. 2, a first set of transversal beams 28 is interposed between subframe 20 and front platform section 12 for supporting the latter. A second set of transversal beams 30 is fixedly attached to each side of mainframe 18 and to rear section platform 14, so as to support the latter. Subframe 20 is pivotally attached to mainframe 18 by means of a pair of hinges 32. It is to be noted that front platform 12 is not compelled to mainframe 18, so that the latter can pivot relative to the former.

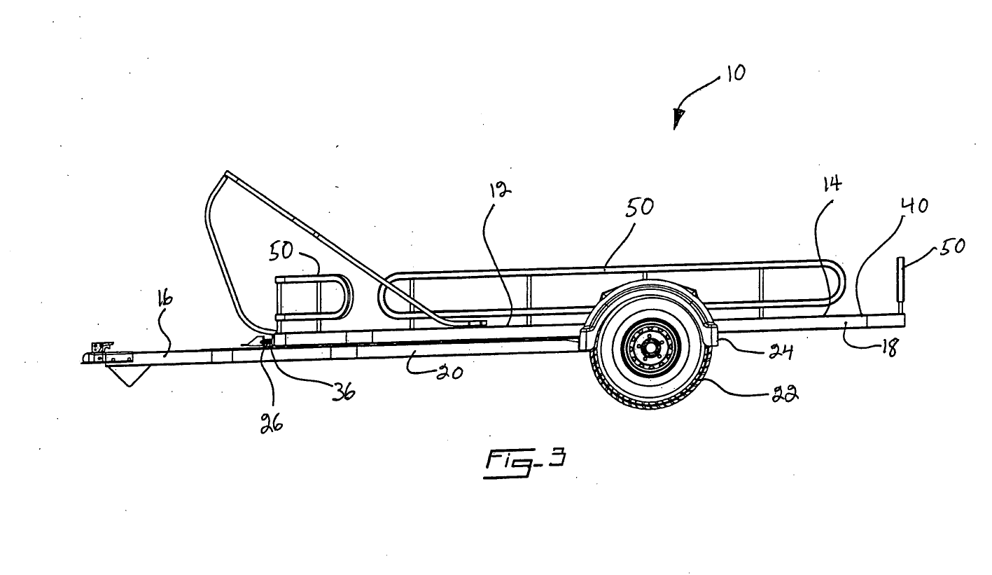

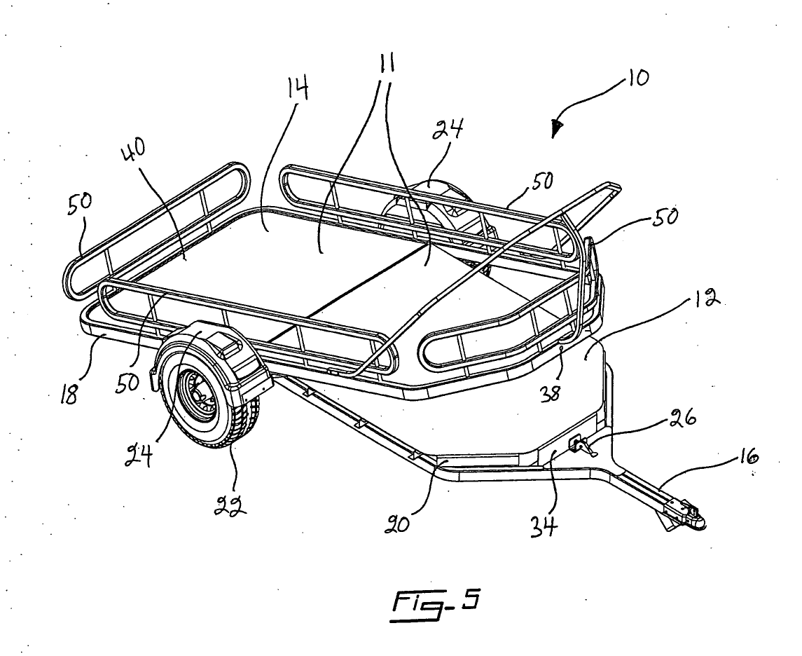

Now referring to FIGS. 1 and 3, pin assembly 26 is mounted on a bridging element 34, the latter in turn being mounted on subframe 20. Pin assembly 26 comprises a pin 36 (FIG. 3) so positioned as to be complementary to an opposite hole 38 (FIG. 5) defined in mainframe 18. Pin 36 is resiliently attached to pin assembly 26, for example by means of a spring, in such a manner that pin 36 can be manually moved away from hole 38 in mainframe 18, whereas the spring brings back pin 36 toward and into hole 38 in mainframe 18 when the pin assembly 26 is released. A free end of pin 36 can be beveled so as to facilitate its insertion into hole 38.

When trailer 10 is in a locked position, i.e. when pin 36 is engaged in hole 38, front platform section 12 and rear platform section 14 are leveled so as to form a substantially flat surface of the overall platform 11. When trailer 10 is in an unlocked position, i.e. when pin 36 is disengaged from hole 38, mainframe 18 and rear platform section 14 can pivot together relative to front platform section 12, such that a rear end 40 of rear platform section 14 moves toward the ground. It is to be noted that when pin 36 is disengaged from hole 38, a front portion of mainframe 18 can be used as a lever so as to control a pivotal movement of mainframe 18 and rear platform section 14 relative to subframe 20 and front platform section 12.

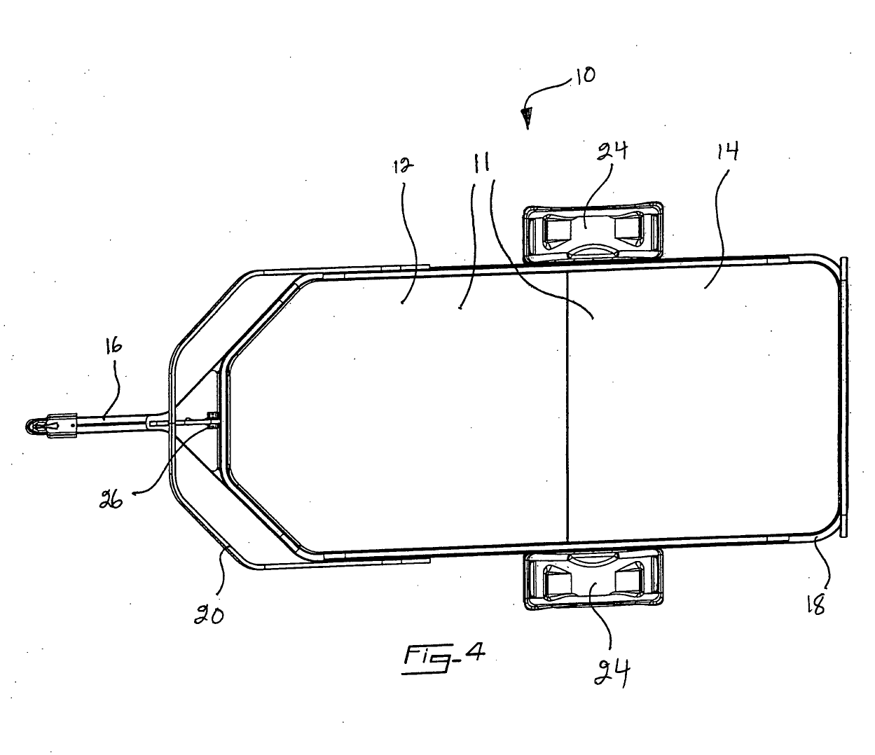

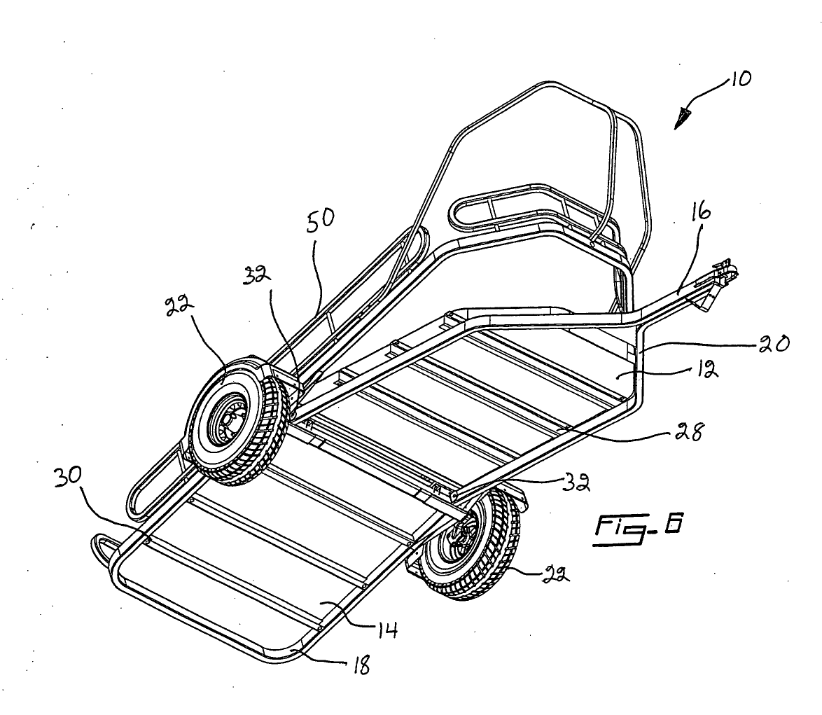

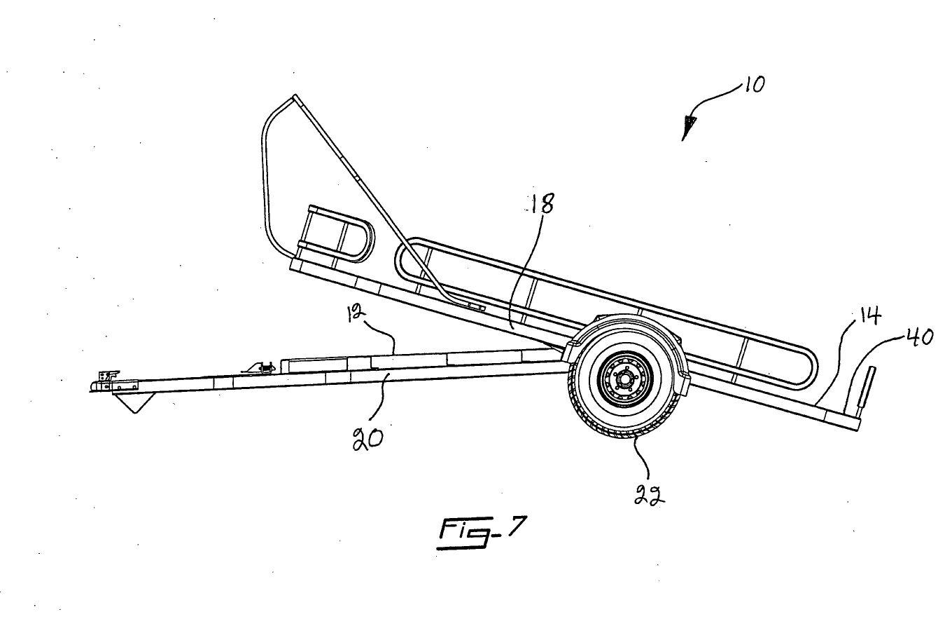

Referring now to FIGS. 5 to 7, in the unlocked position of the trailer 10, the rear end 40 of rear platform section 14 is lowered to the ground, so as to facilitate the loading (and unloading) of an object on (and from) the trailer 10 via the rear platform section 14, such as a lawn mower or a quad. Then, trailer 10 is brought back to the locked position, thus enabling trailer's 10 loading of the object by means of the rear platform section 14 being level (as can be seen on FIGS. 1 to 4) with front platform section 12.

Although the present invention has been described hereinabove by way of non-restrictive, illustrative embodiments thereof, these embodiments can be modified at will, within the scope of the appended claims, without departing from the spirit and nature of the subject invention.

1. A trailer comprising:
a mainframe;
a subframe pivotally attached to the mainframe;
a first platform section attached to the mainframe;
a second platform section attached to the subframe; and
a retaining means for attaching the mainframe to the subframe; the retaining means being adapted, when released, to allow the first platform section to pivot relative to the second platform section.
